(19) United States
(12) Patent Application Publication
(10) Pub. No.: US 2014/0288995 A1
(43) Pub. Date: Sep. 25, 2014

(54) CRITICALITY SPATIAL ANALYSIS

(71) Applicant: Regents of the University of Minnesota, Minneapolis, MN (US)

(72) Inventors: Andrew George Huff, Albuquerque, NM (US); Shaun P. Kennedy, North Oaks, MN (US); Amy Lynn Kircher, St. Paul, MN (US); John Thomas Hoffman, Black Mountain, NC (US)

(73) Assignee: Regents of the University of Minnesota, Minneapolis, MN (US)

(21) Appl. No.: 14/212,749

(22) Filed: Mar. 14, 2014

Related U.S. Application Data
(60) Provisional application No. 61/784,675, filed on Mar. 14, 2013.

(51) Int. Cl. G06Q 10/06

(52) U.S. Cl. CPC G06Q 10/0635
USPC 705/7.28

(57) ABSTRACT

A system includes a processor, a memory and a user interface. The processor has an input port to receive node data, path data, and spatial data. The node data corresponds to nodes in a system. A node is associated with a facility in a food supply chain. The path data corresponds to connectivity between nodes along paths. The paths are associated with nodes in the food supply chain. The spatial data corresponds to nodes or paths. The memory stores executable instructions for accessing risk data associated with at a node, a path, or a food item. The instructions generate output data based on the node data, the path data, the spatial data, and the risk data. The output corresponds to criticality of the food supply chain. The user interface receives user-selected input data as to the food supply chain and provides the output data.

### CLAIM OF PRIORITY

This patent application claims the benefit of priority of U.S. Provisional Patent Application Ser. No. 61/784,675, filed on Mar. 14, 2013, which is hereby incorporated by reference herein in its entirety.

### STATEMENT REGARDING FEDERALLY SPONSORED RESEARCH OR DEVELOPMENT

This invention was made with Government support under 2010-ST-061-FD0001-03 awarded by U.S. Department of Homeland Security. The Government has certain rights in the invention.

### BACKGROUND

Food and agriculture comprise a systems-based infrastructure that contains a complex and dynamic network of individual processes and facilities. The world relies upon this system for a reliable and safe source of food. However, there are many threats that can disrupt the food system. Disruption can be caused by a hurricane, a terrorist, a flood, foreign animal disease, or other factors.

Food system security can be evaluated in terms of vulnerability, risk, and criticality assessments. Past efforts to address these risks are based on qualitative and highly subjective methodology. The reliance on highly subjective and qualitative methodology is problematic due to the unreliability, poor outcome validity, and disparate systems comparability. In the United States, for example, the need for quantitative and practical assessment methodologies led to National Center for Food Protection and Defense's (NCFPD) development of the Food and Agriculture Systems Criticality Assessment Tool (FASCAT). FASCAT was developed to assist in implementing one of the Department of Homeland Security's (DHS) National Infrastructure Protection Plan (NIPP) requirements to determine the criticality of all food systems' infrastructure by providing a quantitative, comparative method of identifying critical food systems.

FASCAT provides a method to assess the criticality of food systems-based on the system's characteristics instead of subjective opinions and qualitative metrics. FASCAT and similar systems have been beneficial to the government and the private sector but they have shortcomings in the manner of data collection and reporting. For example, FASCAT does not depict a comprehensive view of the food supply system.

FASCAT allows the user to select threats, consequences and characteristics in tabular form and to output criticality information in the form of ranked scores. FASCAT does not provide insights into the nature of the supply chain, its geographical locations or relative position within a supply chain or in relation to other supply chains.

### Overview

Collecting spatial data of food systems can help in recognizing the size or scope of the system being analyzed, the complexity of the system, and the impact that geographical and inter-related infrastructure differences have on system vulnerability, risk, and criticality.

An example of the present subject matter provides risk assessments that are able to adapt to complex and dynamic food systems. A quantitative, spatially explicit, simple, and affordable food system criticality assessment tool can track food from farm to fork and prevent food systems failures.

For example, a distribution house can receive raw ingredients from multiple suppliers and when those ingredients are moved from the distribution house, the resulting stream of ingredients are comingled. If one of a plurality of suppliers provides contaminated ingredients to the distribution house, it can be difficult to trace the source. An example of the present subject matter allows for food supply chain analysis and can be applied to assist in identifying the contaminated source.

One example of the present subject matter includes a cloud-based service that combines web and spatial technology to assess criticality.

An example includes a flexible, user-friendly, geographical information systems (GIS)-based, informative web-based spatial criticality assessment and supply chain documentation tool. One example includes a tool configured to collect and display complex systems of spatial data. The tool can display large amounts of dynamic food network information gathered from a number of stakeholders.

One example can reduce the potential for contamination at a point along the food supply chain and facilitate mitigating potentially catastrophic public health and economic effects of such attacks. Multiple data streams can be fused to identify and locate components of a product or ingredient: supply chain management, logistics, epidemiology, risk assessment, economics, molecular biology, and food microbiology, biomedical engineering, toxicology, and risk communication.

An example enables a user to identify reasonably known and foreseeable hazards, risks, and weapons of mass destruction (WMD) threats to their products. A supply chain wide surveillance system can monitor protective programs and can be configured to detect hazards and WMD agents. The system can also assess risk of intentional adulteration and anticipate incidences and provide data to defend against this threat.

A user can, for example, create, read, update and delete a food network model. The model can be assigned a risk score-based on attributes of the model using an algorithm executed on a processor. In addition, one example allows for enhanced GIS capability and enhanced charting and reporting functions.

A user can include a privately owned food company or a government agent. An example is scalable to allow analysis of a small sized state level firm to a large international level firm (small and medium size firms have less resources to protect their systems). One example allows exchange of food systems data between privately owned companies and government data sets.

In various examples, the present subject matter can objectively identify specific nodes, transportation routes, or links in the foods system that are fragile, heavily relied upon, or at high risk of failure. Knowledge of the interdependencies in a system of food supply chains can help stakeholders adjust to changing circumstances with the prospect of decreasing the costs of security and foodborne illness while increasing the ability of the food system to ensure a safe and reliable food supply. A spatial methodology such as provided by one example of the present subject matter allows a user to evaluate mitigation and recovery strategies in food systems. One example provides a user-friendly web-based GIS platform to enter or manipulate data and to display the results of the analyses in a graphic representation on a selected scale for the specific firm, state government, or federal agency.

Various examples include a spatial systems-based methodology to document food systems and a GIS platform to collect and display food systems data. This can also improve regulatory compliance and allow assessment of spatial vulnerability, risk, and criticality. Simulations can also be conducted to develop and analyze mitigation strategies in privately owned food systems.

An example of the present subject matter blends transaction information in the food supply chain and uses spatial data analysis and scoring information to determine why some elements are more critical than other elements.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a block diagram of a system, according to one example.

FIG. 2 illustrates a pictorial diagram of a system according to one example.

FIG. 3 illustrates a screen image corresponding to a node, according to one example.

FIG. 4A illustrates a food system network, according to one example.

FIG. 4B illustrates a food system network relative to a geographical region.

FIG. 5 illustrates a flow chart of a method according to one example.

### DETAILED DESCRIPTION

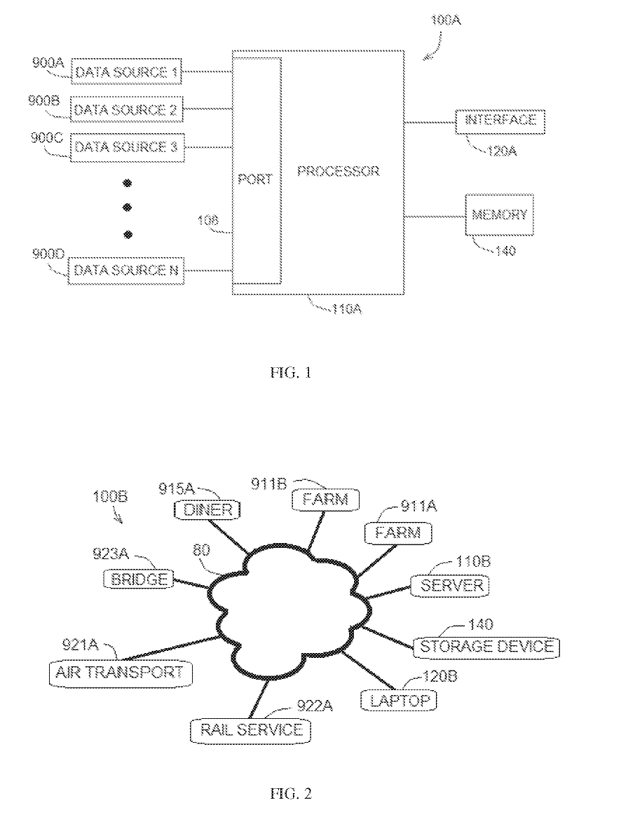

FIG. 1 illustrates a block diagram of system 100A. System 100A includes processor 110A coupled to interface 120A and coupled to memory 140. In addition, processor 110A includes port 108 which is coupled to data source 900A, data source 900B, data source 900C, and data source 900D. The vertically aligned ellipse symbol indicates that any number of data sources can be coupled to processor 110A.

Processor 110A can include a digital processor, an analog processor, or a look-up table. In one example, processor 110A includes a server.

Port 108 can include circuitry, hardware, and software to exchange data between a selected data source (such as data source 900A) and processor 110A. In various examples, port 108 includes an analog-to-digital converter (ADC) or a digital-to-analog converter (DAC), a filter, an amplifier, or other circuitry.

Interface 120A can include circuitry, hardware, and software to exchange data between a user (not shown) and processor 110A. By way of examples, interface 120A can include a computer (such as a laptop), a keyboard, a cursor control device, a display, a printer, or a network interface (to allow communicating with a remote device).

Memory 140 can include a storage device such as a hard drive, a removable media device, a non-removable media device. In various examples, memory 140 includes storage for data generated by processor 110A or used by processor 110A, data provided by a data source (such as data source 900A). In one example, memory 140 provides storage for instructions which, when executed by processor 110A, cause processor 110A to perform a method as described elsewhere in this document.

Data sources 900A-900D can include a node. A node can include a facility such as an agriculture source (such as a farm), a transfer station (site where food or food ingredients) are moved, a manufacturing plant (such as a facility that processes or handles a food item), a processing plant (that provides other food processing services), a retail facility (such as a grocery store, restaurant, or convenience store, or a vending machine.

In addition, data sources 900A-900D can include a path. A path can include a potential transportation route or modality that carries a food item or related goods (such as packaging containers for a particular food item). In various example, a data source (such as data source 900A) can include a maritime shipping service, an air transport service, a rail service, a trucking service.

In the case of a path, data sources 900A-900D can provide data as to shipping capacity, shipping rates (pecuniary and bulk amounts), a route, terminal information, equipment details, service information, or other data that touches the matters of food safety and risk. An example can also be used to analyze surge capacity associated with replacing a missing node or path which forces people to change behavior and change the loading on other system components.

Processor 110A can be coupled to interface 120A by a wired or wireless communication link. In addition, processor 110A can be coupled to memory 140 by a wired or wireless communication link. Processor 110A, in the example illustrated, includes port 108, however, in other examples, port 108 and processor 110A are separate components coupled by a wired or wireless link. In addition, port 108 is coupled to data sources 900A-900D by a wired or wireless link. The links illustrated in FIG. 1 can be unidirectional (for example, data source 900A provides information to processor 110A) or can be bidirectional (for example, data source 900B can provide data to processor 110A and can receive instructions or data from processor 110A).

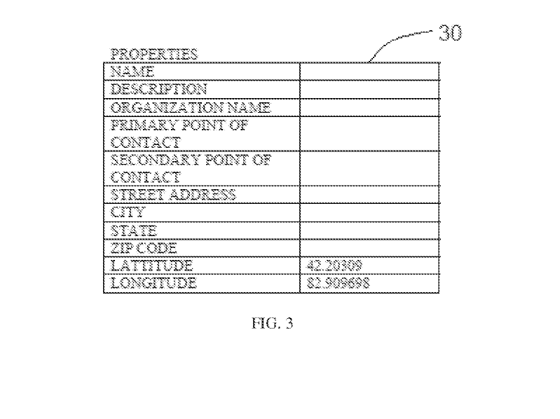

FIG. 2 illustrates a pictorial diagram of system 100B. System 100B includes network 80, sometimes referred to as a cloud. Network 80 can include a plurality of wired or wireless elements and can provide data communication over a local or wide area. In one example, network 80 includes wireless elements and is accessible through the internet.

System 100B can include processor 110B, here illustrated as a server, coupled to network 80. In addition, system 100B includes memory 140, here illustrated as a storage device separately coupled to network 80, and in various examples, is directly coupled to processor 110B. Network 80 is shown connected to interface 120B, here illustrated as a laptop computer and having a keyboard, touchpad (cursor control), and a display screen.

Network 80 is shown coupled to various data sources, some of which include nodes and some of which include paths. System 100B includes data sources 911A and 911B (here illustrated as agricultural farms) and data source 915A (here illustrated as a diner or restaurant). In addition, system 100B includes data source 923A (here illustrated as a bridge and representing, for example, an over-the-road trucking service), data source 921A (here illustrated as an air transport service), and data source 922A (here illustrated as rail transport service).

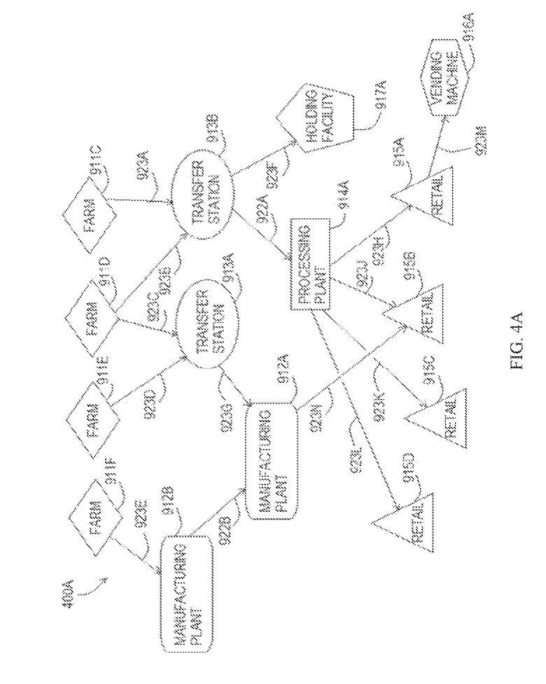

FIG. 3 illustrates an example of data corresponding to a data source, such as data source 900A. In the figure, table 30 provides a framework for storing information about a facility, such as a farm or a restaurant. The data stored in the fields of table 30 can include static information regarding a responsible party and information regarding geographical coordinates and postal address or street address information.

In other examples, a data source can provide information regarding facility performance, capacity, and archival data. The information can be provided by manual entry, by accessing an enterprise resource planning (ERP) system, or by site-specific sensors located at the site of the facility.

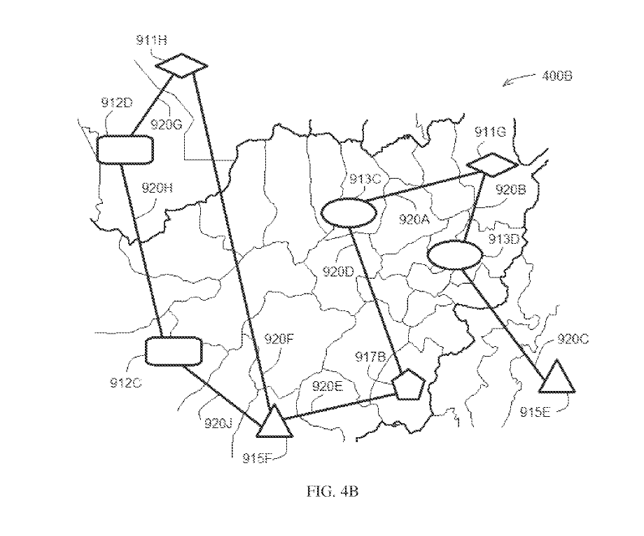

FIG. 4A illustrates food system network 400A. Network 400A includes a plurality of nodes, including nodes 911C, 911D, 911E, and 911F, each of which is indicated as a farm. In the example shown, the farms are at the origin of a food chain, however, it will be appreciated that upstream suppliers to a farm can be identified. For example, a farm receives agricultural products such as animal feed, seeds, and other materials that can be viewed as upstream elements for which another degree of relatedness can be identified.

In addition, network 400A illustrates that nodes 911C, 911D, 911E, and 911F each produce products that are carried downstream to other nodes. For example node 911C provides products to node 913B (here indicated as a transfer station) via path 923A (here corresponding to a roadway). Node 911D (also shown as a farm) provides products to node 913B via path 923B and to node 913A (also shown as a transfer station) via path 923C. Node 911E provides product to node 913A via path 923D. Node 911F provides product to node 912B (here denoted as a manufacturing plant) via path 923E. In this example, paths 923A, 923B, 923C, 923D, and 923E are each a roadway.

In addition, node 912B provides products to node 912A via path 922B. Node 913B provides product to node 914A (here indicated as a processing plant) via path 922A. Paths 922A and 922B represent rail routes.

Node 913B provides product to node 917A (here indicated as a holding facility) via path 923F (a roadway). Node 914A provides products to node 915A, node 915B, node 915C, and node 915D, via path 923H, path 923J, path 923K, and path 923L, respectively. Node 915A, node 915B, node 915C, and node 915D are indicated as retail facilities which can represent a grocery store, restaurant, or other facility that services consumers. In addition, node 915B receives product from node 912A via path 923N (a roadway) and node 916A (here shown as a vending machine) receives product via path 923M (a roadway).

Both the nodes and paths of network 400A are elements that can affect the food supply chain and thus, can be evaluated using an example of the present subject matter. For example, a path represented as a roadway can be affected by a road or bridge closure, a weight restriction, a speed limit, traffic, a detours, and other factors. Certain of these characteristics can be compiled and used in the calculation of assessing criticality. Other characteristics can be evaluated in real time, or near real time. For example, an automobile accident or traffic volume can affect the flow of goods. Accident and traffic data can be compiled using a camera or road sensor and provided to a processor configured to assess criticality. In addition, weather or other phenomenon (man-made or natural), can also affect the flow of food or food items.

Network 400A represents an example of a food system that can be analyzed using the present subject matter. Other configurations of nodes and paths, and other numbers of network elements, are also contemplated.

A score of criticality can be calculated for each node or path. A spatial location (expressed, for example, in latitude and longitude coordinates) and non-spatial attributes (some examples of which are shown in FIG. 3) can be calculated or entered for each node in a network or for each path in a network.

In some examples, a node or a path can be characterized by user selection of a value or attribute from an available list of tools presented on a dashboard.

FIG. 4B illustrates food system network 400B relative to a geographical region. Network 400B includes nodes 911G and 911H, here denoted as farms. In addition, node 913D and node 913C (both represented here as transfer stations) receive goods via path 920B and 920A, respectively. In addition, node 911H provides product to node 912D (here represented as a manufacturing plant) via path 920G. Node 912D provides product to node 912C (also a manufacturing plant) and in turn, to node 915F (a retail facility) via path 920H and path 920J. Node 915F also receives product directly from node 911H via path 920F. Node 915F also receives product from node 917B (shown as a holding facility) which, in turn, receives product from node 913C, via path 920E and path 920D, respectively. Node 915E (shown as a retail facility) receives product from node 913D, via path 920C.

In this figure, paths 920A, 920B, 920C, 920D, 920E, 920F, 920G, 920H, and 920J each represent paths that could include a roadway, a rail line, a maritime shipping lane, an air route, or other path of commerce.

The map indicated in the background of network 400B represents a geographical region in which the products move. The locations of the various nodes are shown in good alignment with the geographical coordinates represented in the map. In one example, the node locations are represented as longitudinal and latitude coordinates. The locations can also be identified using global position system (GPS) or postal addresses (street address).

The locations of the various paths in network 400B are indicated as direct connections. In other views, the present subject matter allows depiction of the paths using an overlay that represents the actual path over the terrain. Like the nodes, the various paths can be affected by spatial phenomenon.

In addition to depicting the geographical features and boundaries, additional overlays can also be shown using various examples of the present subject matter. For example, a hazard layer can be shown as an overlay atop the image shown in FIG. 4B. A hazard layer can include a weather condition, a man-made condition, or other factor. In addition, the overlay can be associated with a cost. In particular, travel over a pathway in good weather conditions is far less risky than travel over the same pathway during a blizzard or hurricane. This difference in conditions can be represented as a cost function in an example of the present subject matter.

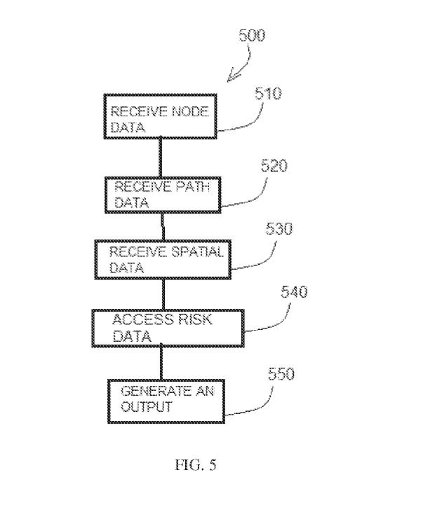

FIG. 5 illustrates flow chart 500 corresponding to a method according to one example. At 510, method 500 includes receiving node data. Node data can include attributes and characteristics that correspond to a particular node. This can include entity name and identification information, personnel data, contact information, street address, geographical coordinates, production or processing capacity, and other data that touches the food supply chain. In one example, the node data is derived from a private data source such as ERP data or from manually entered data.

At 520, method 500 includes receiving path data. Path data can include route information, capacity, availability, transit costs, transit time, end point locations, weight or size restrictions, or other factors that touch on the food supply chain.

At 530, method 500 includes receiving spatial data. Spatial data can include coordinates of the various nodes and paths, forward path data and backward path data. In addition, spatial data can represent geographical-based conditions such as weather, natural phenomenon, man-made conditions, hazards, or other factors.

At 540, method 500 includes accessing risk data. The risk data can correspond to a particular node, a particular path or any combination of nodes and paths. In addition risk data can correspond to risks associated with intentional contaminants or unintentional contaminants.

At 550, method 500 includes generating an output. The output can include a criticality score for a particular node, a particular path, or a combination of nodes and paths. In addition, the output can be represented as a map or geographical overlay.

According to one example, a spatial component is used to strengthen and objectively measure vulnerability, risk, and criticality. GIS data can convey risk information by virtue of a visual representation of risk and can be used to compute spatial analysis. With stratified decision-making in government and private sector organizations, the ability to rapidly communicate risk through visual display eases the burden of comprehension.

Spatial analysis of risk can be complicated by missing data, merging disparate types of data, and the difficulty of determining causation. Nevertheless, spatial criticality analysis can be effective. By openly presenting criticality assessment details and assumptions spatially, rather than allowing them to remain implicit, analysts will not mislead those affected by the outcomes of vulnerability, risk, and criticality analysis. Criticality can be depicted using a spatial approach based on a combination of GIS and criticality analysis.

One example enables private sector food companies to increase the use of vulnerability, risk, and consequence assessments by easy to use, web and systems-based spatial analysis methodologies to increase global food system resiliency, thereby reducing their costs. Counterintuitive to past business practices, food systems owners can share proprietary data with competitors and government agents via a secure communication network. An example can be configured to retrieve system food supply chain structure data automatically from a private company.

Selected features of various examples of the present subject matter include the following:
1. A user-friendly graphical user interface (GUI) that documents assets and subsystems within the system;
2. Modalities for product movement between assets;
3. Geo-spatial and temporal characterization of system components for private sector food companies;
4. A spatial systems-based criticality assessment;
5. Supply chain business rules from private sector partnerships that are flexible and responsive to market conditions;
6. Supply chain subsystem (e.g., liquid milk) vulnerability assessments to apply to systems identified as being critical by users;
7. Models that predict the effects of multiple hazards to food systems simultaneously;
8. Algorithms to join the disparate models' output or data;
9. Product or commodity spatial tracking data within facilities collected through private industry and/or government partnerships;
10. Facility-based spatial data through private industry and/or government partnerships;
11. Subsystems-based spatial data through private industry and/or government partnerships;
12. Systems-based spatial data through private industry and/or government partnerships;
13. A strong evaluation program, including measures of adoption and utilization of spatial systems-based criticality analysis in the private sector;

Tracing food products is difficult due to the commingling of different batches of food ingredients during food manufacturing, and the subsequent use of manufactured food products as ingredients in different food products further down the supply chain. The ability to track and trace ingredients in the system has multiple benefits to include: the identification of risk; rapid assessments of sourcing in a continuously changing global landscape; and, the ability to rapidly and efficiently trace food products backwards and forwards for rapid foodborne epidemiologic and environmental investigations in unintentional and intentional food contamination events.

Some government regulations require companies involved in food production and distribution to track their supply stream. Many food companies are unable to trace food products outside of their system.

GIS and relational database architecture of one example of the present subject matter can reduce the complexity of multiple independent food systems and supply chains. Spatial relationships can be used reduce system complexity and provide industry and government with traceability information (e.g., locations of where food products and ingredients are purchased from and where they are sent) that can reduce the duration and incidence of food contamination events.

Criticality assessments can strengthen food supply chain systems by providing a targeted focus for threat mitigation. Criticality assessments can be used to rank order disparate food assets and systems-based upon characteristics (e.g., viable threats, known vulnerabilities, known consequences, and the magnitude of primary, secondary, and third order effects to critical interdependent infrastructures). For example, if a milk system is poisoned or contaminated in a specific location that services a large area, the first order consequences are that people become ill, then the second order effects are that hospitals are overwhelmed due to insufficient emergency surge capacity, and then the third order effects are that unrelated emergency surgeries that require similar medications for treatment become difficult to obtain at the national level. Criticality assessment methodology can rank order disparate food systems in a way that enables policy makers to efficiently allocate security resources.

One example of the present subject matter is directed to criticality assessments for complex interconnected food systems networks. One example of the present subject matter can identify fragile food systems that require attention or resources to enhance system resiliency and improve business continuity. One example identifies and rank orders critical nodes in food systems, which results in the efficient allocation of scarce security resources, increased system diversification, and enhanced business continuity (e.g., the identification of one sole supplier or location that provides all of a key commodity, product, or ingredient to multiple systems and results in the development of back-ups or redundant systems). A simulation can enable food companies to proactively address potential threats, thereby reducing costs to government regulators and private industry, and increase the availability, hazards resiliency, and continuity of food and healthcare systems.

### Supply Chain Documentation

The way food products travel from farm to fork is complex. Often when food contamination occurs, whether unintentional or intentional, the government and private industry is unable to identify the contaminated food products due to the high variability in systems' characteristics and the limited view any one food company has of the food system. When contamination events occur, obtaining accurate information quickly can reduce casualties and business costs.

One example of the present subject matter identifies and utilizes characteristics of the assets across disparate food systems, modalities for product movement between assets, geo-spatial and temporal characterization of assets, transportation networks, and business rules for how these variables fluctuate based on market conditions, environmental factors, and their reliance on related infrastructures (e.g., water and electricity). Information as to where and how food products are transferred and flow between independent food systems can simplify the process of epidemiologic food trace back and trace forward investigations. The supply chain process includes two separate components that utilizes spatial systems-based graphical user interface (GUI) and data collection from private industry partners, and is further described in other portions of this document. Supply chain documentation can facilitate sharing food systems information with regulators and private industry collaborators objectively identifying specific points in the foods system that are fragile and at high risk of failure and critical interdependencies for food system infrastructure, enabling private food companies to identify and mitigate their specific threats in advance, decreasing the costs of security and foodborne contamination to the private sector and government increasing the strength of the food system to ensure a safe and reliable food supply; and significantly decreasing the incidence of foodborne illness.

### Food Systems GUI and Spatial Database

Food system modeling does not typically follow a spoke and hub model, static schematic, and flow chart. Instead, food systems are typically continuous and dynamic processes. Static models of food systems are inaccurate and can lead to problems when conducting epidemiologic food trace back and trace forward investigations. Epidemiologists and private industry rely upon inaccurate food systems models to determine where contaminated food products originate. To address this problem, one example of the present subject matter includes an interface that enables the private industry system owner to update their systems' flow charts in real time. This enables users to identify, assess, and mitigate risks in a constantly changing environment. A GUI enables a user to edit the food supply chain to match the food system and capture the locations of ingredient suppliers, transportation routes and modalities, and the distribution of finished product.

A GUI allows a user to select a food product, commodity, or commonly used food ingredient from a drop down menu or free text. Selection of the drop down menu populates a generic flow chart in the GUI. After the flow chart is populated, the user can edit the flowchart by selecting objects with a pointing device (e.g., mouse) and then dragging the objects and dropping them into different positions, editing, adding, or removing nodes as necessary, and editing the lines which represent the movement of products between nodes. For each node, a user can provide information to describe the system model (e.g., coordinates of the facility; type of facility; facility name or identification number; specific products or ingredients purchased, processed, and distributed; quantity of product; frequency of receipt or distribution; water source; and power source). One example includes an interface having pop-up boxes to key terms, operational definitions, and provides multiple pathways to accomplish certain tasks within the software.

The collected information is stored in the spatial relational database. Upon entering information associated with first edited node, the GUI prompts the user to provide the transportation information for the previously entered product data. This information includes mode of transportation, such as shipping via air, water, and ground; the route transported (if known); and the duration of travel (if known or estimated).

In one example, enterprise resource planning (ERP) software for logistics management can be used to electronically link data system to an example of the present subject matter. A database stored in a memory can provide certain information. As the data are collected, the data needed for research, analysis, epidemiologic investigations, FSMA compliance, business continuity, and to reduce foodborne illnesses can be gathered and assembled.

Some food companies' systems do not reach from farm to fork. Since many producers do not control their entire supply chain, there can be incomplete sections within the data model. One example uses third party documentation to supply missing information for the supply chain. Since spatial coordinates of food systems nodes are collected, a spatial database can spatially join the two related but independently owned and operated food systems, thus extending the model to the farm or the fork.

A particular farm is unique and can provide different input/ingredient information, because there have been instances where intentional and unintentional contamination occurs at or before the farm.

### Supply Chain Criticality Assessment

The criticality assessment rank orders the criticality of disparate food systems. Criticality assessment can be used by state governments for critical infrastructure identification and to comply with reporting regulations.

A high level model of one example can include a plurality of data layers. One data layer provides economic data that assess economic consequences in dollars. One data layer provides public health data that quantifies foodborne pathogens, investigation protocols, and medical staffing levels in the event of a contamination event. One data layer provides weather data derived from government or private sources and quantifies risk-based on hurricane or flood data. One data layer provides seismic data which quantifies risk-based on earthquake risk model data. One data layer provides transportation data and quantifies risk-based on likelihood and identification of critical transportation route failure. One data layer provides food system data and generates food system attributes-based on batch sizes, production to consumption speed, amount of nodes, reliance upon connected nodes, geographic area covered and system complexity.

The data layers are provided to a spatial database. The spatial database is used by a scoring algorithm in analyzing criticality. The scoring algorithm is also informed by the transportation data layer and the food system data layer. The results of the scoring algorithm is used to determine spatial systems-based analysis of criticality.

### Economic Model

An economic model determines the costs of a food system failure to the private industry and government regulators and provides the ability to simulate economic disasters. To drive the spatial economic model, an assessment package including data and software provides economic spatial resolution from the national level to the county level). In one example, IMPLAN or CFCRR data are used. The IMPLAN or CFCRR data model includes spatially specific data for economies at the local, state, or federal levels. IMPLAN or CFCRR data files can be used for examining the economic consequences of food contamination events to determine how these events will impact a population. The data can also determine how the economy in one location affects surrounding and related areas by estimating regional imports and exports. Economic modeling of food product flow between locations can facilitate vulnerability, risk, and criticality assessment.

### Public Health Model

The public health model can determine how likely a state or region will be able to identify a foodborne disease outbreak and is able to compute/simulate public health investigation response to a food contamination event. Public health characteristics vary across regions. These variations result in regional differences in public health preparedness and response. One example of the present subject matter is configured to detect, investigate and respond to foodborne outbreaks dependent on several variables (e.g., reporting requirements for foodborne pathogens, foodborne investigation protocols, and medical staffing levels). Some characteristics for detection, investigation and response are defined government documents. The public health model uses (without limitation) these characteristics to determine how likely states (or regions) are to identify a food outbreak and respond appropriately. If a food product were only distributed regionally, in states with limited capabilities to detect and respond to a foodborne outbreak, this would increase the impact of an outbreak. Likewise, if a product were distributed to a region, with high capabilities to detect and respond to a foodborne outbreak, the scope and impact of the outbreak would be reduced. The output of the public health model can be factored into the impact assessment of a contaminated product.

### Meteorological Model

A tornado model determines how likely an area is to be in the path of a tornado, flood, or hurricane and is able to compute/simulate the impact these events have to a food system. Tornadoes, floods, and hurricanes are capable of destroying or disrupting critical food systems facilities and transportation routes, and location-based prediction of weather related events are a well-developed facet within the spatial sciences and GIS. One example of the present subject matter utilizes existing tornado, flood, and hurricane weather models and National Oceanic and Atmospheric Administration (NOAA) data to determine the likelihood of these events occurring at any specific point within a country. The likelihood of a tornado, flood, and hurricane occurring at any one point can be modeled, and then these risks can be evaluated for specific areas of interest. With a weather hazard model, food companies and government regulators can predict where tornadoes, floods, and hurricanes are most likely to occur. Tornado, flood, and hurricane model data can help determine which specific food system nodes are at risk to these adverse events, and this spatial data can be incorporated into vulnerability, risk, and criticality scoring.

### Seismic Activity Model

The seismic activity model determines likelihood that an area will be affected by seismic activity and is able to compute/simulate the impact these events have to a food system. An earthquake can have devastating impacts on critical food infrastructures and transportation systems. One example incorporates existing United States Geological Survey (USGS) earthquake models to determine the likelihood of these geological events occurring at any specific location. As with the weather model, the likelihood of an earthquake occurring at any one point can be modeled, and then the risks can then be evaluated for specific areas of interest. With an earthquake hazard model, private sector and government risk managers can predict where earthquakes are likely to occur. Earthquake model data can determine which specific food system nodes are at risk and spatial earthquake risk data will be incorporated into vulnerability, risk, and criticality scoring, which can contribute to a methodological approach.

### Transportation Model

The transportation model determines how important a route and method of transportation is to a food system, and is able to compute/simulate the impact the failure the transportation route has to the food system. Based upon the type of route selected, a cost surface can be applied to account for transportation characteristics that affect transportation time and economic efficiency. The transportation model can use data collected from government data, which can include business rules for commodity movements, spatial and GIS-based commodity movement data, transportation modality data, and foreign animal disease modeling data. This model is able to fill in the spokes for the food systems model, and can calculate the criticality of the route-based upon the failure of the transportation method, compared to the cost and availability of the next best transportation alternative (method and route). This information is able to enhance the systems modeling component, and is therefore a factor of the vulnerability, risk, and criticality scoring.

### Food Systems Characterization Score

The food systems characterization score determines the criticality of the system in combination with the transportation model. The food systems characterization score is driven by data collected in the food systems GUI during the food system documentation to determine the criticality-based upon food systems characteristics. One example includes an ordinal score for each commodity system-based upon the sizes of the food batch produced, average portion size consumed, production to consumption time (as calculated between factory production time and transportation time collected in the transportation model), the complexity of the system-based upon the amount of system nodes for the identified commodity system, geographic footprint of the distribution of the product, and the human population of the geographic distribution footprint. The combination of these factors determines the score of each individual system, or network of systems.

### Algorithm

The output of the above models can be combined to create the overall scoring of spatial risk and criticality. Combining the data uses an algorithm to combine several disparate spatial risk model outputs with varying types of data distributions (e.g., economic interval scale vector data; weather ordinal scale raster data; transportation ratio scale vector data; etc.). This algorithm relies upon fuzzy logic. Fuzzy logic allows for the use of approximate values and inferences and incomplete or ambiguous data, as opposed to only relying on completely certain, valid, and reliable data in probabilistic theory. In one example, the algorithm combines the data and stores is in a spatial database where it can be retrieved for scenario planning, GIS mapping, and visualization of systems vulnerability, risk, and criticality. The combination of the models is able to produce an all hazards overview of food systems vulnerability, risk, and criticality.

### End-Users

The end-users of one example include the government agents, federal agencies, and private industry. One example is able to benefit the private food and agriculture firms that operate food infrastructure at local, state, regional, national, and global levels. One example of the present subject matter is scalable and can be applied in a centralized or decentralized manner. Disparate systems can be linked to create uniformity in data collection and vulnerability, risk, and criticality analysis. One example can aggregate and promote generalized data on supply chain structure, identify selected components of the food systems, and enable collaboration between system owners and government regulators, to mitigate food system disruption and mitigate food contamination (intentional and unintentional).

One example includes a spatial and relational network model, which layers and analyzes data from manual input or automatic retrieval. Data layering can provide a platform for assessing risk and vulnerability to determine critical elements of a system.

### Additional Notes

Biological hazards can be tabulated in a manner to illustrate the food commodities typically associated with unintentional contamination of commodities, selected symptoms, and an indication of disease adjusted life years (DALY). DALY provides a measure of risk. Table 1 (below) is a tabulation of selected biological hazards.

TABLE 1

| | Food commodities | | |
|---|---|---|---|
| Biological | (unintentional | | Individual |
| hazard | contamination) | Selected Symptoms | DALY |
| Bacillus | Baby food products | Emetic syndrome (nausea, | 0.003 |
| cereus | Confections and | vomiting and malaise) | |
| | frostings | Diarrheal syndrome | |
| | Dairy product analogs | (diarrhea with abdominal | |
| | Dietary supplements | pain) | |
| | Egg products | | |
| Brucella | Cheeses and cheese | fever, sweats, malaise, | 4.9 |
| suis | products | anorexia, headache, pain in | |
| | Fresh meats | muscles, joint, and/or back, | |
| | Meat products | fatigue: recurrent fevers, | |
| | Milk and Milk | arthritis, swelling of the | |
| | products | testicle and scrotum area, | |
| | | swelling of the heart | |
| | | (endocarditis), neurologic | |
| | | symptoms, chronic fatigue, | |
| | | depression, swelling of the | |
| | | liver and/or spleen | |
| Campylobacter | Cheeses and cheese | Diarrhea, cramping, | 0.01 |
| spp. | products | abdominal pain, and fever | |
| | Fruit and water ices | lasting arthritis. Guillain- | |
| | Meat products | Barré syndrome | |
| | Milk and Milk | | |
| | products | | |
| | Poultry products | | |
| Clostridium | Canned food products | Fatality rate: 3-5% | 14.6 |
| botulinum | Cheeses and cheese | Paralytic illness (double | |
| | products | vision, blurred vision, | |
| | Condiments and | drooping eyelids, slurred | |
| | relishes | speech, difficulty | |
| | Confections and | swallowing, dry mouth, | |
| | frostings | and muscle weakness). | |
| | Dairy product analogs | Severe botulism (30%) | |
| | Fish products | intensive medical care for | |
| | Fresh vegetables | several months and long- | |
| | Fresh fish and seafood | term health effects | |

Others biological hazards can also be tabulated, including: Clostridium perfringens, Cryptosporidium spp., STEC Escherichia coli O157:H7, STEC non-0157, Giardia spp., Hepatitis A, Listeria monocytogenes, Mycobacterium bovis, Norovirus Rotavirus, Salmonella spp. Nontyphoidal, Salmonella spp. Typhoidal, Shigella, Staphylococcus aureus, Toxoplasma gondii, Trichinella, Vibrio spp., and Yersinia enterocolitica

### Foodborne Pathogens

Foodborne pathogens can be ranked using an example of the present subject matter. Pathogen contamination and food pathogens can be treated in a single category or treated as separate categories.

A user interface, according to one example can be configured to operate as follows:
1. Select intentional contamination or unintentional contamination.
2. Select the food category (using a drop down list). Food categories can be correlated with a government-specified categorization. Four such categories are shown here but more complete listing can be any number in length:
   a. Baked goods and baking mixes: all ready-to-eat and ready-to-bake products, flours, and mixes requiring preparation before serving.
   b. Canned food products (low acid and acidified)
   c. Dairy product analogs: non-dairy milk, frozen or liquid creamers, coffee whiteners, toppings, and other non-dairy products.
   d. Egg products: liquid, frozen, or dried eggs, and egg dishes made therefrom, i.e., egg roll, egg foo young, egg salad, and frozen multicourse egg meals, but not fresh eggs.
3. Depending on the food commodity, display the related food pathogen (DALY Table) using a drop down list or by presenting options for user selection. Four categories are shown below but the actual number of categories is not limited.
   a. Bacillus cereus
   b. Brucella suis
   c. Campylobacter spp.
   d. Clostridium botulinum
4. Prompt the user to enter the number of serving sizes per production batch/lot. A serving represents a combination of time data, spatial data, and quantity. This data can be collected using ranges or can be specified by the user as an actual numbers. Four ranges are shown here but the actual number is not limited.
   a. 1-1,000
   b. 1,000-50,000
   c. 50,000-100,000
   d. 100,000-1,000,000
5. Calculate the total DALY values for each of the pathogens as follows:

TOTAL DALY VALUE/100,000 population=Individual DALY VALUE×Number of serving sizes per lot.
6. Risk ranking. Assign a risk score based on the total DALY value.

| Total DALY value | Risk score |
|---|---|
| 0.1-1,000 | 1 |
| 1,000-5,000 | 2 |
| 5,000-20,000 | 3 |
| 20,000-100,000 | 4 |
| 100,000-500,000 | 5 |
| 500,000-2,000,000 | 6 |
| 2,000,000-10,0000 | 7 |
| 10,000,000-50,000,000 | 8 |

### Example Menu of Reports

One example of the present subject matter accesses supply chain data and reports assessment results as an output. The output can include a display of current risk scoring for each supply chain component or subsystem viewed as well as specifically configured reports.

Report options can be presented to a user in a menu. The user can select from the menu. The following is an example of a report menu.

### Menu Contents:

1. Geographical representation of a selected supply chain or for a specified portion of that supply chain.
2. Tabular listing of the component systems/node that make up a supply chain that includes the key characteristics of each component and transportation link.
3. A summary report of the prioritized scores for each component and transportation link within the supply chain.
4. A listing of supply chain components and transportation links within a geographical area for a selected supply chain.
5. A listing of supply chain components or facilities by type within that supply chain.
6. A listing of firm operated or contract components or facilities by type across all supply chains.
7. A listing of supply chain components or facilities by threat or hazard type.
8. A listing of all supply chain components and transportation links involved in a selected ingredient or product component.
9. A report of all supply chain components that employ a specific transportation type or routing.
10. A listing of components or facilities shared by selected supply chains.
11. A user configurable report based on a selection from a menu of supply chain component characteristics. Geographic area or a score threshold.

### Functionality for One Example

a. A user friendly User Interface;
b. A role-based user nomination and access system;
c. Compartmentalized and access documented user access system;
d. “Point and Shoot” supply chain builder tool;
e. Documented components of supply chain from initial agriculture operations through retail distribution;
f. Provides a tool box and palette for building a supply chain within a geographical environment;
g. Provides a tabular view of key descriptive and characteristic data for each supply chain component;
h. Provide a GIS-based view of the supply chain components with layers of natural risk, zone threats, political, transportation and infrastructure information;
i. Document and catalog the key characteristics of each component subsystem within the supply chain;
j. Document the transportation linkage, along with the type and characteristics of the transportation link between each supply chain component subsystem;
k. Document the hazards/threats for each component subsystem and transportation link within the supply chain:
   a. These hazards/threats can include:
      i. Geographic naturally occurring hazards—made visible via a GIS layer;
      ii. Point hazards/threats for each component subsystem;
      iii. Area or zone threats and subsystem type threats;
l. Document potential or actual transportation link routing between component subsystems within the supply chain;
m. Document a comparative risk score for each component of the supply chain (based on a scoring algorithm);
n. Document first, second and third order linkages between components of a supply chain and across supply chains when appropriate access is provided between compartmentalized data sets;
o. Document transaction data for inputs to supply chain components that has been entered into the supply chain characteristics data for each supply chain component subsystem (can be input manually or provided directly from the firm's ERP system) so as to document the quantities, characteristics, sources and movement of ingredients and products through the supply chain;
p. Provide customized report outputs generated from a menu of outputs.

An output is useful, actionable information for the users. The present subject matter can fulfil several purposes. In one example, the output provides a model by which a user can build a geo-spatial-based documentation of their supply chain. In one example, a user can identify the critical, high consequence, components or subsystems within that supply chain. A consequence is defined as those that impact the viability of the supply chain (infrastructure) and impact upon the health of the consumers of the products produced by the supply chain. In one example, the output can reveal the potential for system functional disruptions if a node fails, is destroyed or is contaminated and what the alternatives are available to the supply chain operators. In one example, the output can assist with product or ingredient tracing through the supply chain. In one example, after having documented the supply chain, each node or component within the supply chain can be assessed and a score generated for it. A ranked listing of these components can guide the supply chain operator in deploying resources and can help to protect the supply chain from the impact of both natural and intentional events. An example can identify cross linking of supply chains and potential cross over points between supply chains where a contaminant or other insult can then propagate even further producing wide adverse impacts. In addition, an example can help identify transportation links, their nature, and associated risks to the function of the supply chain or propagation of risks.

Risk scoring, according to the present subject matter, entails combining both a geographic approach (as in hurricane, flood, earthquake, weather, other natural disasters, as well as disease and infrastructure events within the transportation, energy, water, etc., sector events that impact the functionality/operation of the food infrastructure in a geographic region) with point events, such as an intentional acts targeting a facility or point on the ground, with external or foreign events that impact the operation of a supply chain, with consequences outside of the infrastructure such as public health, food sufficiency, nutrition availability and related shortages. Scoring is a combination of scoring values based upon the specific characteristics and importance/significance of certain types of events as they relate to functionality of the system and a DALY score that rates and event in terms of both public health impact and man days or productivity lost due to mortality and morbidity.

The geographic context of any given component of a supply chain can impact consequences and, therefore, the criticality of that supply chain component, its impact on the overall supply chains and upon the end users of its products (consumers and their public health). As with weather modeling, an example combines geo-spatial data with threats and the construct and components of the supply chain as it actually exists on the ground and how its components are linked together by transportations systems and how ingredients/products flow through the supply chain to the end users. This enables the rapid identification of potential cross overs between supply chains for insults of any kind that can propagate, then, along and through other supply chains with adverse impacts.

A variety of data types are utilized in an example of the present subject matter. For example, digital records from transactions between buyers and sellers across a supply chain (either manually or electronically) can characterizes the components of the supply chain. In addition, the transportation links and the nature of the movement through the supply chain, and the processes involved in the production and distribution of a food product intended to be in retail trade are all data components collected in one example. The data can be from both the provider of the ingredient/product input as well as from the providers of ingredients/products to that provider.

In the present subject matter, the GUI has been built as a very user friendly tool for the creation of geo-spatial-based supply chain documentation. In one example, a user employs a tool palette from which to select supply chain components and add them to the supply chain construct in a graphical form where each component has descriptive and functional attributes and can be linked within the supply chain with the other components of that supply chain. The relationship to other supply chains within that firm or those of other interacting (supplier or customer) firms can be displayed and assessed for significance and risk. Output can be in the form of graphics that are geographic or in tabular reports as described earlier.

The GUI allows the user to input point threats, system threats or geographic threats from user selected menus and to manually input new threats. Selection of new threats from the built-in menu or from manual input of threats then affects the score that is calculated by the present system. It will also enable the user to see where the threats may manifest consequences in terms of product produced, in terms of servings or other outputs to product consumers. This will aid in both product tracing and “what if” modeling. For example, some very specific food agent mix data for high risk foods and agents of concern, however, this data cannot be pre-coded since these data points are currently classified by the United States Government. In this case, the present subject matter enables the user to input a threat type and aid in determining the level of impact in terms of product output. The DALY scores leverage established consequence values for certain types of contaminations and biohazards (as well as some chemical hazards). This enables us to assign consequence scores without having to cross into any classified research products. This approach enables the user to arrive to essentially the same consequence assessment outcome.

Examples of the present subject matter can be applied in a centralized and decentralized manner. For a typical large, multinational or national firm where all such risk assessment work is very highly proprietary and all done in house and closely controlled (up to the point where they are required to share the information with FDA in any event investigation) and they must also be able to demonstrate to FDA upon any inspection that they have the capacity to do such supply chain documentation and risk assessment in a rapid manner. In another example, a user is the small to mid-sized firm with only a small IT infrastructure and limited resources and expertise in maintaining such a capability. In such a case there must be a capability to provide access to and use of such a system on a hosted basis where the tool is employed, in a secure manner, via a VPN link to a service provided, such as NCFPD or its commercial entity/representative who provides access to the tool as a service.

### Various Notes & Examples

Example 1 can include subject matter (such as an apparatus, a method, a means for performing acts, or a storage device or other tangible nontransitory device-readable medium including instructions that, when performed by the device, cause the device to perform acts) that can include or use a processor, a memory, and a user interface. The processor has an input port configured to receive node data, receive path data, and receive spatial data. The node data corresponds to a plurality of nodes in a system. A node is associated with a facility in a food supply chain. The food supply chain is configured to produce and supply a food item. The path data corresponds to connectivity between nodes along a plurality of paths. The paths are associated with nodes in the food supply chain. The spatial data corresponds to at least one node or at least one path. The memory is coupled to the processor and configured to store executable instructions for accessing risk of disruptive burden data associated with at least one node, at least one path, or the food item and generating output data based on the node data, the path data, the spatial data, and the risk of disruptive burden data. The output corresponds to criticality of the food supply chain. The user interface is configured to receive user-selected input data corresponding to the food supply chain and configured to provide the output data.

Example 2 can include or use, or can optionally be combined with the subject matter of Example 1 to optionally include, use, or provide that the output data is configured for storage in the memory.

Example 3 can include or use, or can optionally be combined with the subject matter of one or any combination of Examples 1 or 2 to optionally include, use, or provide that the user interface is configured to receive a measure of criticality associated with at least one of a node, a path, an element of spatial data, and risk of disruptive burden data.

Example 4 can include or use, or can optionally be combined with the subject matter of one or any combination of Examples 1 through 3 to optionally include, use, or provide that the executable instructions are configured to determine a criticality value associated with at least one node, a path, spatial data, and risk of disruptive burden data.

Example 5 can include or use, or can optionally be combined with the subject matter of one or any combination of Examples 1 through 4 to optionally include, use, or provide that the executable instructions are configured to determine a ranked order of a criticality value associated with at least one node, a path, spatial data, and risk of disruptive burden data.

Example 6 can include or use, or can optionally be combined with the subject matter of one or any combination of Examples 1 through 5 to optionally include, use, or provide that the executable instructions are configured to compare a first output data and a second output data, wherein the first output data corresponds to a first node data, a first path data, a first spatial data, and a first risk of disruptive burden data and wherein the second output data corresponds to a second node data, a second path data, a second spatial data, and a second risk of disruptive burden data.

Example 7 can include or use, or can optionally be combined with the subject matter of one or any combination of Examples 1 through 6 to optionally include, use, or provide that the user interface is configured to receive spatial data including data as to a natural phenomenon, contamination data, adulteration data, disease data, food supply chain disruptive data, or infrastructure data associated with a transportation system, an energy network, or a utility network.

Example 8 can include or use, or can optionally be combined with the subject matter of one or any combination of Examples 1 through 7 to optionally include, use, or provide that the user interface is configured to receive spatial data as to a particular node or path.

Example 9 can include or use, or can optionally be combined with the subject matter of one or any combination of Examples 1 through 8 to optionally include, use, or provide that the user interface is configured to receive data as to public health, food sufficiency, nutrition availability, and distribution of a resource.

Example 10 can include or use, or can optionally be combined with the subject matter of one or any combination of Examples 1 through 9 to optionally include, use, or provide that the user interface is configured to receive at least one of geographical location information or a position of a first node or a first path relative to a second node or second path.

Example 11 can include or use, or can optionally be combined with the subject matter of one or any combination of Examples 1 through 10 to optionally include, use, or provide that the user interface is configured to receive a descriptive attribute.

Example 12 can include or use, or can optionally be combined with the subject matter of one or any combination of Examples 1 through 11 to optionally include, use, or provide that the user interface is configured to receive a functional attribute.

Example 13 can include or use, or can optionally be combined with the subject matter of one or any combination of Examples 1 through 12 to optionally include, use, or provide that the user interface is configured to receive data using a graphical user input.

Example 14 can include or use, or can optionally be combined with the subject matter of one or any combination of Examples 1 through 13 to optionally include, use, or provide that the user interface is configured to receive data from an enterprise resource planning (ERP) system.

Example 15 can include or use, or can optionally be combined with the subject matter of one or any combination of Examples 1 through 14 to optionally include, use, or provide that the executable instructions are configured to generate ranked criticality data.

Example 16 can include or use subject matter (such as an apparatus, a method, a means for performing acts, or a device-readable medium including instructions that, when performed by the device, can cause the device to perform acts), such as can include or use receiving node data, receiving path data, receiving spatial data, accessing risk of disruptive burden data, and generating an output. Receiving node data includes receiving data that corresponds to a plurality of nodes in a system. A node is associated with a facility in a food supply chain. The food supply chain is configured to produce and supply a food item. Receiving path data includes receiving data that corresponds to connectivity between nodes along a plurality of paths. The paths are associated with nodes in the food supply chain. Receiving spatial data includes receiving data that corresponds to at least one node or at least one path. Accessing risk of disruptive burden data including accessing data associated with at least one node, at least one path, or the food item. Generating the output includes generating based on the node data, the path data, the spatial data, and the risk of disruptive burden data. The output corresponds to criticality of the food supply chain.

Example 17 can include, or can optionally be combined with the subject matter of Example 16, to optionally include storing the output in a storage device.

Example 18 can include, or can optionally be combined with the subject matter of one or any combination of Examples 16 or 17, to optionally include receiving a user input as to a measure of criticality associated with at least one of a node, a path, an element of spatial data, and risk of disruptive burden data.

Example 19 can include, or can optionally be combined with the subject matter of one or any combination of Examples 16 through 18, to optionally include wherein generating the output includes determining a criticality value associated with at least one node, a path, spatial data, and risk of disruptive burden data.

Example 20 can include, or can optionally be combined with the subject matter of one or any combination of Examples 16 through 19, to optionally include wherein generating the output includes determining ranked order of a criticality value associated with at least one node, a path, spatial data, and risk of disruptive burden data.

Example 21 can include, or can optionally be combined with the subject matter of one or any combination of Examples 16 through 20, to optionally include wherein the node data, the path data, the spatial data, and the risk of disruptive burden data are associated with a first data set and associated with a second data set, wherein the first data set differs from the second data set and wherein generating the output includes comparing the first set with the second set.

Example 22 can include, or can optionally be combined with the subject matter of one or any combination of Examples 16 through 21, to optionally include wherein receiving spatial data includes receiving data as to a natural phenomenon, contamination data, adulteration data, disease data, food supply chain disruptive data, or infrastructure data associated with a transportation system, an energy network, or a utility network.

Example 23 can include, or can optionally be combined with the subject matter of one or any combination of Examples 16 through 22, to optionally include wherein receiving spatial data includes receiving data as to a particular node or path.

Example 24 can include, or can optionally be combined with the subject matter of one or any combination of Examples 16 through 23, to optionally include wherein receiving spatial data includes receiving data as to public health, food sufficiency, nutrition availability, and distribution of a resource.

Example 25 can include, or can optionally be combined with the subject matter of one or any combination of Examples 16 through 24, to optionally include wherein receiving spatial information includes receiving at least one of geographical location information or a position of a first node or a first path relative to a second node or second path.

Example 26 can include, or can optionally be combined with the subject matter of one or any combination of Examples 16 through 25, to optionally include wherein receiving node data includes receiving data using a graphical user input.

Example 27 can include, or can optionally be combined with the subject matter of one or any combination of Examples 16 through 26, to optionally include wherein receiving node data includes receiving a descriptive attribute.

Example 28 can include, or can optionally be combined with the subject matter of one or any combination of Examples 16 through 27, to optionally include wherein receiving node data includes receiving a functional attribute.

Example 29 can include, or can optionally be combined with the subject matter of one or any combination of Examples 16 through 28, to optionally include wherein receiving path data includes receiving data using a graphical user input.

Example 30 can include, or can optionally be combined with the subject matter of one or any combination of Examples 16 through 29, to optionally include wherein receiving spatial data includes receiving user-entered data at a user-operable interface.

Example 31 can include, or can optionally be combined with the subject matter of one or any combination of Examples 16 through 30, to optionally include wherein at least one of receiving node data, receiving path data, and receiving spatial data includes receiving data from an enterprise resource planning (ERP) system.

Example 32 can include, or can optionally be combined with the subject matter of one or any combination of Examples 16 through 31, to optionally include wherein at least one of receiving node data, receiving path data, and receiving spatial data includes receiving user-entered data and wherein generating the output includes generating ranked criticality data.

Example 33 can include, or can optionally be combined with the subject matter of one or any combination of Examples 16 through 32, to optionally include receiving a user-specified measure of criticality and wherein generating the output includes calculating a value using the user-specified measure of criticality.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher level language code, or the like. Such code can include computer-readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A system comprising:
a processor having an input port configured to receive node data, receive path data, and receive spatial data, the node data corresponding to a plurality of nodes in a system, wherein a node is associated with a facility in a food supply chain, the food supply chain configured to produce and supply a food item, the path data corresponding to connectivity between nodes along a plurality of paths, the paths associated with nodes in the food supply chain, and the spatial data corresponding to at least one node or at least one path;
a memory coupled to the processor and configured to store executable instructions for accessing risk of disruptive burden data associated with at least one node, at least one path, or the food item and generating output data based on the node data, the path data, the spatial data, and the risk of disruptive burden data, the output corresponding to criticality of the food supply chain; and
a user interface configured to receive user-selected input data corresponding to the food supply chain and configured to provide the output data.

2. The system of claim 1 wherein the output data is configured for storage in the memory.

3. The system of claim 1 wherein the user-interface is configured to receive a measure of criticality associated with at least one of a node, a path, an element of spatial data, and risk of disruptive burden data.

4. The system of claim 1 wherein the executable instructions are configured to determine a criticality value associated with at least one node, a path, spatial data, and risk of disruptive burden data.

5. The system of claim 1 wherein the executable instructions are configured to determine a ranked order of a criticality value associated with at least one node, a path, spatial data, and risk of disruptive burden data.

6. The system of claim 1 wherein the executable instructions are configured to compare a first output data and a second output data, wherein the first output data corresponds to a first node data, a first path data, a first spatial data, and a first risk of disruptive burden data and wherein the second output data corresponds to a second node data, a second path data, a second spatial data, and a second risk of disruptive burden data.

7. The system of claim 1 wherein the user interface is configured to receive spatial data including data as to a natural phenomenon, contamination data, adulteration data, disease data, food supply chain disruptive data, or infrastructure data associated with a transportation system, an energy network, or a utility network.

8. The system of claim 1 wherein the user interface is configured to receive spatial data as to a particular node or path.

9. The system of claim 1 wherein the user interface is configured to receive data as to public health, food sufficiency, nutrition availability, and distribution of a resource.

10. The system of claim 1 wherein the user interface is configured to receive at least one of geographical location information or a position of a first node or a first path relative to a second node or second path.

11. The system of claim 1 wherein the user interface is configured to receive a descriptive attribute.

12. The system of claim 1 wherein the user interface is configured to receive a functional attribute.

13. The system of claim 1 wherein the user interface is configured to receive data using a graphical user input.

14. The system of claim 1 wherein the user interface is configured to receive data from an enterprise resource planning (ERP) system.

15. The system of claim 1 wherein the executable instructions are configured to generate ranked criticality data.

16. A computer-implemented method comprising:
receiving node data corresponding to a plurality of nodes in a system, wherein a node is associated with a facility in a food supply chain, the food supply chain configured to produce and supply a food item;
receiving path data corresponding to connectivity between nodes along a plurality of paths, the paths associated with nodes in the food supply chain;
receiving spatial data corresponding to at least one node or at least one path;
accessing risk of disruptive burden data associated with at least one node, at least one path, or the food item; and
generating an output based on the node data, the path data, the spatial data, and the risk of disruptive burden data, the output corresponding to criticality of the food supply chain.

17. The method of claim 16 further including storing the output in a storage device.

18. The method of claim 16 further including receiving a user input as to a measure of criticality associated with at least one of a node, a path, an element of spatial data, and risk of disruptive burden data.

19. The method of claim 16 wherein generating the output includes determining a criticality value associated with at least one node, a path, spatial data, and risk of disruptive burden data.

20. The method of claim 16 wherein generating the output includes determining ranked order of a criticality value associated with at least one node, a path, spatial data, and risk of disruptive burden data.

21. The method of claim 16 wherein the node data, the path data, the spatial data, and the risk of disruptive burden data are associated with a first data set and associated with a second data set, wherein the first data set differs from the second data set and wherein generating the output includes comparing the first set with the second set.

22. The method of claim 16 wherein receiving spatial data includes receiving data as to a natural phenomenon, contamination data, adulteration data, disease data, food supply chain disruptive data, or infrastructure data associated with a transportation system, an energy network, or a utility network.

23. The method of claim 16 wherein receiving spatial data includes receiving data as to a particular node or path.

24. The method of claim 16 wherein receiving spatial data includes receiving data as to public health, food sufficiency, nutrition availability, and distribution of a resource.

25. The method of claim 16 wherein receiving spatial information includes receiving at least one of geographical location information or a position of a first node or a first path relative to a second node or second path.

26. The method of claim 16 wherein receiving node data includes receiving data using a graphical user input.

27. The method of claim 16 wherein receiving node data includes receiving a descriptive attribute.

28. The method of claim 16 wherein receiving node data includes receiving a functional attribute.

29. The method of claim 16 wherein receiving path data includes receiving data using a graphical user input.

30. The method of claim 16 wherein receiving spatial data includes receiving user entered data at a user-operable interface.

31. The method of claim 16 wherein at least one of receiving node data, receiving path data, and receiving spatial data includes receiving data from an enterprise resource planning (ERP) system.

32. The method of claim 16 wherein at least one of receiving node data, receiving path data, and receiving spatial data includes receiving user entered data and wherein generating the output includes generating ranked criticality data.

33. The method of claim 16 further including receiving a user-specified measure of criticality and wherein generating the output includes calculating a value using the user-specified measure of criticality.
